(19) United States
(12) Patent Application Publication
(10) Pub. No.: US 2026/0340084 A1
(43) Pub. Date: Oct. 29, 2026

(54) INFORMATION PROCESSING APPARATUS AND INFORMATION PROCESSING METHOD

(71) Applicant: Kioxia Corporation, Tokyo (JP)

(72) Inventor: Kengo NAKATA, Kawasaki (JP)

(73) Assignee: Kioxia Corporation, Tokyo (JP)

(21) Appl. No.: 19/571,735

(22) Filed: Mar. 19, 2026

(30) Foreign Application Priority Data
Apr. 28, 2025 (JP) 2025-074772

(51) Int. Cl. G06F 18/2431; G06F 18/2413

(52) U.S. Cl. CPC G06F 18/2431; G06F 18/24147

(57) ABSTRACT

An information processing apparatus includes a first storage device that stores a first threshold for determining a magnitude of information relating to k distances representing differences in feature between a first data item and k second data items resembling the first data item; a second storage device that stores a second threshold for determining a magnitude of a number of classes for classifying the k second data items; and processing circuitry configured to search for the k second data items; calculate the information relating to the k distances; calculate the number of classes; and determine a third data item to be data out of a distribution range of a plurality of the second data items, wherein the third data item is the first data item in a case that the calculated information is greater than the first threshold or the calculated number of classes is greater than the second threshold.

### CROSS-REFERENCE TO RELATED APPLICATION

This application is based upon and claims the benefit of priority from Japanese Patent Application No. 2025-074772, filed Apr. 28, 2025, the entire contents of which are incorporated herein by reference.

### FIELD

Embodiments described herein relate generally to an information processing apparatus and an information processing method.

### BACKGROUND

Techniques of inferring a class of image data (hereinafter, input data) that is input into a trained image recognition model are known. A technique for detecting, in such inference, that input data is out-of-distribution (OOD) data, which is out of the range of image data items used in the training of an image recognition model (hereinafter, learned data items) is under study.

In a case where OOD data is input into a trained image recognition model, the image recognition model fails to output a correct result that is originally expected, thus failing to achieve a recognition accuracy that is accomplished at the time of the training. For this reason, it is desired to exclude OOD data from input data items in inference using a trained image recognition model.

However, among input data items, an input data item that should be basically regarded as OOD data and excluded but resembles the learned data items is difficult to detect as OOD data. For example, in a case where the learned data items, which are data items including cat images and dog images, and an input data item includes a fox image, which is a data item not having been learned, the input data item may not be regarded as OOD data and excluded because foxes resemble both cats and dogs.

### BRIEF DESCRIPTION OF THE DRAWINGS

FIG. 1 is a block diagram illustrating a general configuration of an information processing apparatus according to an embodiment.

FIG. 2 is a diagram illustrating an example of an effective number of classes calculated by a first-number-of-classes calculating unit.

FIG. 3 is a graph illustrating an example of distances between reference data items and classes of the reference data items.

FIG. 4 is an exemplary table showing labels of k reference data items and distances to the k reference data items.

FIG. 5 illustrates an example of a plot in which plotted points representing distance related information items and effective numbers of classes of a plurality of reference data items are applied to a two-dimensional coordinate space represented by a distance and an effective number of classes.

FIG. 6 is a flowchart illustrating a process of setting a first threshold and a second threshold.

FIG. 7 is a flowchart illustrating a process of determining in-distribution (ID) data and out-of-distribution (OOD) data.

### DETAILED DESCRIPTION

Hence, an embodiment will provide an information processing apparatus and an information processing method capable of excluding OOD data included in input data input into a trained model, with high accuracy.

In general, according to one embodiment, to solve the above problem, there is provided an information processing apparatus including: a first storage device configured to store a first threshold for determining a magnitude of information relating to k distances representing differences in feature between a first data item and k second data items, wherein k is an integer of one or more, and the k second data items resemble the first data item in feature; a second storage device configured to store a second threshold for determining a magnitude of a number of classes for classifying the k second data items according to classes; and processing circuitry that is connected to the first storage device and the second storage device, the processing circuitry is configured to: receive the first data item; search for the k second data items as data items resembling the first data item in feature; calculate the information relating to the k distances representing differences in feature between the received first data item and the k second data items; calculate the number of classes for classifying the k second data items according to the classes; and determine a third data item to be data out of a distribution range of a plurality of the second data items, wherein the third data item is the first data item in a case that the calculated information is greater than the first threshold, and the third data item is the first data item in a case that the calculated number of classes is greater than the second threshold.

Hereinafter, embodiments of an information processing apparatus and an information processing method will be described with reference to the drawings. The following description will focus on principal constituent components of the information processing apparatus. Note that the information processing apparatus can include constituent components and functions that are not illustrated or described. The following description shall not be construed as excluding constituent components and functions that are not illustrated or described.

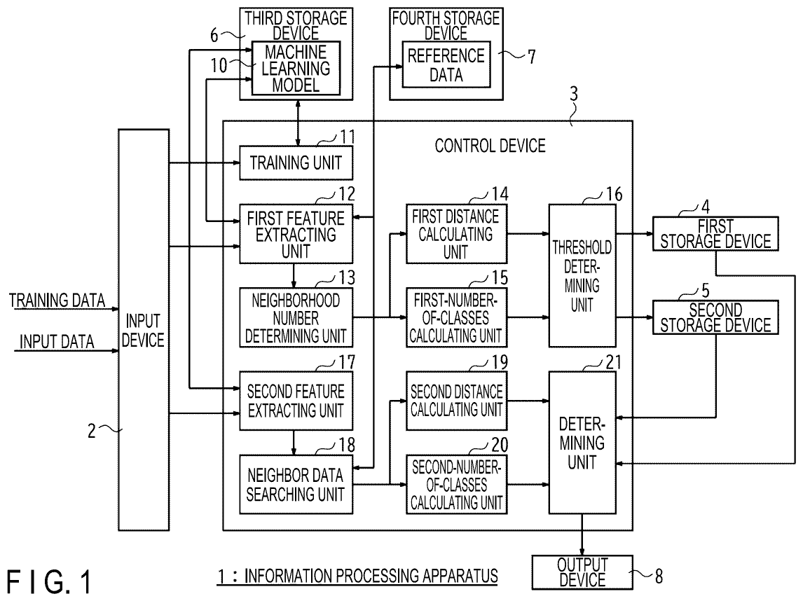

FIG. 1 is a block diagram illustrating a general configuration of an information processing apparatus 1 according to an embodiment. As illustrated in FIG. 1, the information processing apparatus 1 includes an input device 2, a control device 3, a first storage device 4, a second storage device 5, a third storage device 6, a fourth storage device 7, and an output device 8.

The input device 2 inputs input data that is to be determined to be in-distribution (ID) data or out-of-distribution (OOD) data and training data that is data for training a machine learning model 10. The training data has features of which are known. The ID data is data within a distribution range of the training data. The OOD data is data out of the distribution range of the training data. The input data and the training data are each, for example, image data. Note that the input data and the training data may each be any type of data other than image data, such as audio data or video data. Note that, in a case where the machine learning model 10 to be used has already been trained, the input device 2 need not receive the training data. The input device 2 may input data representing features extracted with the trained machine learning model 10.

Processing operation of the control device 3 is implemented by, for example, a computer executing a program. Alternatively, hardware to execute the processing operation of the control device 3, such as a central processing unit (CPU) or a control circuit, may be provided. In some implementations, control device 3 may comprise circuitry or processing circuitry which includes general purpose processors, special purpose processors, integrated circuits, ASICS (“Application Specific Integrated Circuits”), FPGAS (“Field-Programmable Gate Arrays”), and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The control device 3 includes, as functional blocks, a training unit 11, a first feature extracting unit 12, a neighborhood number determining unit 13, a first distance calculating unit 14, a first-number-of-classes calculating unit 15, a threshold determining unit 16, a second feature extracting unit 17, neighbor data searching unit 18, a second distance calculating unit 19, a second-number-of-classes calculating unit 20, and a determining unit 21.

The training unit 11 trains the machine learning model 10 that extracts features of input data. The training unit 11 receives a plurality of training data items the features of which are known, from the input device 2. The training unit 11 inputs the received training data items into the machine learning model 10 to cause the machine learning model 10 to perform an inference process. On the basis of the result of the inference process, the training unit 11 adjusts weight coefficients and the like of the machine learning model 10 such that the machine learning model 10 outputs desired (the known) features.

The machine learning model 10 is stored in, for example, the third storage device 6. The machine learning model 10 is, for example, a neural network. As the machine learning model 10, the third storage device 6 stores, for example, node information, link information, and weight information that constitute the neural network.

The first feature extracting unit 12 receives training data from the input device 2 and extracts the features of the received training data using the training unit 11 and the machine learning model 10. Data representing the features extracted from the training data by the first feature extracting unit 12 will herein be referred to as extracted data. With the first feature extracting unit 12, a plurality of extracted data items are generated from a plurality of training data items. Among the plurality of extracted data items, extracted data items generated with the trained machine learning model 10 represent known features. The first feature extracting unit 12 stores extracted data generated with the trained machine learning model 10 as reference data in, for example, the fourth storage device 7. The third storage device 6 and the fourth storage device 7 may be integrated together. Each of the third storage device 6 and the fourth storage device 7 is a device capable of storing data in a nonvolatile manner. An example of such a device is an SSD. Note that extracted data representing the known features may be input into the first feature extracting unit 12 via the input device 2, instead of the training data. In this case, the extracted data representing the known features and input via the input device 2 is treated as the reference data.

The neighborhood number determining unit 13 determines a neighborhood number k, which is used for searching for k reference data items (k is an integer equal to or greater than 1) that resemble in feature, for each of a plurality of input data items in an inference using the trained machine learning model 10. The reference data items are used to determine a first threshold λd and a second threshold λc for determining the ID data or the OOD data in the inference using the trained machine learning model 10, as will be described later.

The first distance calculating unit 14 receives the neighborhood number k determined by the neighborhood number determining unit 13 and calculates, for each of the k reference data items, distances that are the differences in feature between each of the reference data items and each of the training data items. The feature is given in the form of, for example, a multidimensional vector. Each of the distances is the difference between different multidimensional vectors and a distance based on Euclidean distance or cosine similarity. For example, in a case where the distance is a distance based on the cosine similarity, distance=0 indicates that the features are the same, and distance=1 indicates that the features are completely different. Therefore, the distance has a value between 0 and 1, both inclusive.

The calculation by the first distance calculating unit 14 gives the distances from the k reference data items for one training data item. The first distance calculating unit 14 calculates the mean value of the k obtained distances. The first distance calculating unit 14 may calculate the total sum of the k obtained distances or the maximum value of the k obtained distances. The mean value and the like of the distances between k reference data items and each training data item calculated by the first distance calculating unit 14 will herein be collectively referred to as distance related information.

The first-number-of-classes calculating unit 15 receives the neighborhood number k determined by the neighborhood number determining unit 13 and calculates an effective number of classes for classification of the k reference data items performed according to their classes with the application of labels. The effective number of classes is a value equivalent to the number of labels that reflects the proportions of a plurality of label types included in the k reference data items. The effective number of classes is a value not greater than the total number of the plurality of label types. For example, in a case where labels applied to the k reference data items are animal names, the first-number-of-classes calculating unit 15 applies the labels to the k reference data items according to animal species and calculates an effective number of classes that reflects the proportions of the animal species. In a case where the proportions of the plurality of label types are the same, the effective number of classes matches the total number of the plurality of label types. In a case where the proportions of the plurality of label types are biased, the effective number of classes is smaller than the total number of the plurality of label types.

The threshold determining unit 16 determines the first threshold λd and the second threshold λc such that the total sum of the number of reference data items satisfying a first condition pertaining to the distance related information and the number of reference data items, among the plurality of reference data items, satisfying a second condition pertaining to an effective number of classes included in the k reference data items equals a particular value.

The particular value is a value obtained by multiplying a certain recall set in advance by the number of the plurality of reference data items. The certain recall is a value that can be freely set by a user. The threshold determining unit 16 increases at least one of the first threshold λd and the second threshold λc as the recall increases. As a result, the number of reference data items that are not greater than the first threshold λd and not greater than the second threshold λc increases.

The first condition is the number of reference data items, for each training data item, that make distance related information relating to k distances between k reference data items and each training data item not greater than the first threshold λd.

The second condition is the number of reference data items, among the plurality of reference data items, that make the effective number of classes included in the k reference data items not greater than the second threshold λc.

The first threshold λd is stored in the first storage device 4. The second threshold λc is stored in the second storage device 5. The first storage device 4 and the second storage device 5 may be integrated together. Each of the first storage device 4 and the second storage device 5 is a device capable of storing data in a nonvolatile manner. An example of such a device is an SSD.

The second feature extracting unit 17 receives input data items from the input device 2 and extracts the features of the received input data items using the trained machine learning model 10. The input data items are data items to be subjected to the determination as to ID data or OOD data.

For each of the input data items, the neighbor data searching unit 18 searches the fourth storage device 7 for k reference data items (k is an integer equal to or greater than 1) that resemble in feature, using the k-nearest neighbors algorithm. The number of reference data items searched for by the neighbor data searching unit 18, k, is the same as the neighborhood number k, which is determined by the neighborhood number determining unit 13. For this reason, the neighbor data searching unit 18 receives the neighborhood number k determined by the neighborhood number determining unit 13.

The second distance calculating unit 19 calculates, for each of the input data items, distance related information relating to distances that are the differences in feature between the input data item and the k reference data items searched for by the neighbor data searching unit 18. The distance related information is, for example, the mean value of k distances. The distance related information may be the total sum of the k distances or the maximum value of the k distances.

The second-number-of-classes calculating unit 20 calculates an effective number of classes for classification of the k reference data items searched for by the neighbor data searching unit 18 performed according to their classes with the application of labels. As described above, the effective number of classes is a value that reflects the proportions of the plurality of label types included in the k reference data items, and is a value not greater than the total number of the plurality of label types.

The determining unit 21 determines whether the distance related information calculated by the second distance calculating unit 19 is greater than the first threshold λd and determines whether the effective number of classes calculated by the second-number-of-classes calculating unit 20 is greater than the second threshold λc, for each of the input data items. On the basis of the results of the determinations, the determining unit 21 determines whether each of the input data items is ID data or OOD data. Specifically, the determining unit 21 determines that the input data item is OOD data in a case where the distance related information calculated by the second distance calculating unit 19 is determined to be greater than the first threshold λd or in a case where the effective number of classes calculated by the second-number-of-classes calculating unit 20 is determined to be greater than the second threshold λc. The determining unit 21 determines that the input data item is ID data in a case where the distance related information calculated by the second distance calculating unit 19 is determined to be not greater than the first threshold λd or in a case where the effective number of classes calculated by the second-number-of-classes calculating unit 20 is determined to be not greater than the second threshold λc.

The output device 8 outputs the result of the determination as either ID data or OOD data. The ID data indicates that the input data item is data within the distribution range of the plurality of reference data items.

As seen from the above, the control device 3 searches for k reference data items with features that resemble the feature of an input data item using the k-nearest neighbors algorithm and calculates the distance related information relating to distances representing the differences between the feature of the input data item and the features of the k reference data items. The control device 3 also calculates the effective number of classes for the classification of the k reference data items searched for performed according to their classes with the application of labels. The control device 3 further determines that the input data item is data out of the distribution range of the plurality of reference data items, that is, the OOD data in the case where the calculated distance related information is greater than the first threshold λd or in the case where the calculated effective number of classes is greater than the second threshold λc.

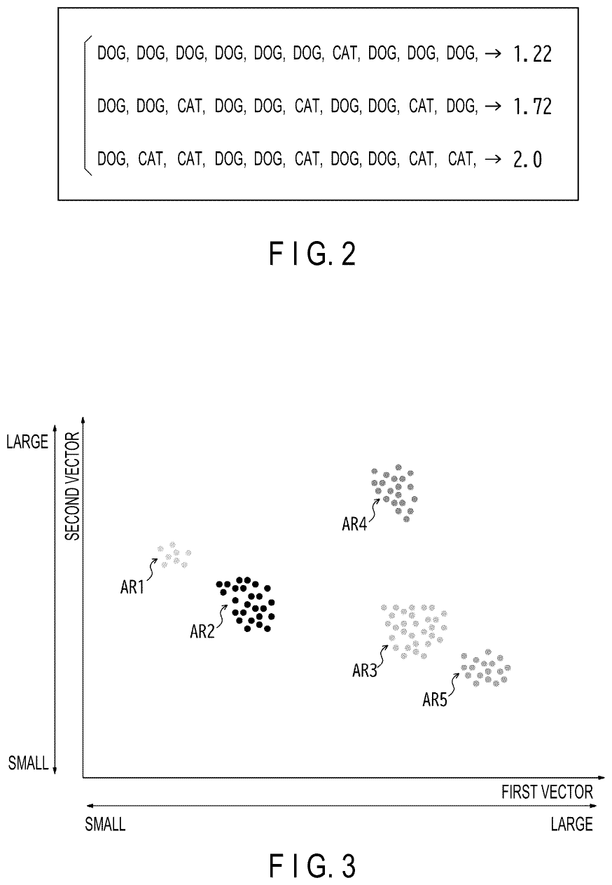

FIG. 2 is a diagram illustrates an example of an effective number of classes calculated by the first-number-of-classes calculating unit 15. In particular, FIG. 2 illustrates a result of a case of k=10, pertaining to 10 reference data items. Here, the 10 reference data items include two label types (e.g., dog and cat). In a case where the 10 reference data items include 9 reference data items indicating dog and 1 reference data item indicating cat, the proportion of the reference data items indicating dog is 0.9, and the proportion of the reference data item indicating cat is 0.1. In this case, an effective number of classes Neff is calculated as about 1.22, on the basis of Expression (1) shown below. In Expression (1), pᵢ denotes the proportion of reference data items with label type i, and N denotes the total number of label types included in the reference data items.

$$\begin{matrix}[ Expression 1 ] & \\ {N}_{eff} = \frac{1}{{\sum }_{i = 1}^{N} {p}_{i}^{2}} & ( 1 )\end{matrix}$$

Likewise, in a case where the 10 reference data items include 7 reference data items indicating dog and 3 reference data items indicating cat, the proportion of the reference data items indicating dog is 0.7, and the proportion of the reference data items indicating cat is 0.3. In this case, the effective number of classes Neff is calculated as about 1.72, on the basis of Expression (1).

Likewise, in a case where the 10 reference data items include 5 reference data items indicating dog and 5 reference data items indicating cat, the proportion of the reference data items indicating dog is 0.5, and the proportion of the reference data items indicating cat is 0.5. In this case, the effective number of classes Neff is calculated as 2.0, on the basis of Expression (1).

As seen from the above, the effective number of classes Neff matches the number N of label types included in k reference data items only in a case where the proportions of a plurality of label types included in the k reference data items are all equal. In a case where the proportions of the types vary, the effective number of classes Neff is a value reflecting the proportions, which is a value smaller than the number of the label types included in the k reference data items. The effective number of classes Neff decreases more as the proportions of the plurality of label types are more biased. The minimum value of the effective number of classes Neff is 1. That is, the effective number of classes Neff can range between 1 and N, both inclusive.

FIG. 3 is a graph illustrating an example of distances between reference data items and classes of the reference data items. FIG. 3 illustrates an example in which the reference data items are image data items including animal images. The plurality of reference data items each represent a feature of an animal image. The features, which are the reference data items, are each constituted by a multidimensional vector. FIG. 3 illustrates a plurality of reference data items located in a two-dimensional coordinate space, with the reference data items being assumed to be each constituted by a two-dimensional vector (a first vector and a second vector). Each of plotted points in FIG. 3 indicates one reference data item. Reference data items including features of animal images of the same species are located in a close area because of their features resembling one another. Areas AR1 to AR5 in FIG. 3 indicate reference data groups that include sets of features of animal images of different species. For example, a plurality of reference data items located within the area AR1 include the features of images of an animal A, while a plurality of reference data items located within the area AR2 include the features of images of an animal B, which is different from the animal A.

The distance between two plotted points in FIG. 3 represents the difference between the features of two corresponding reference data items. The shorter the distance, the higher the similarity between the two reference data items.

The neighborhood number determining unit 13 determines the neighborhood number k used for searching for k reference data items that resemble an input data item in feature. Depending on the value of k, some of the k reference data items determined by the neighborhood number determining unit 13 may be different in class from original reference data items.

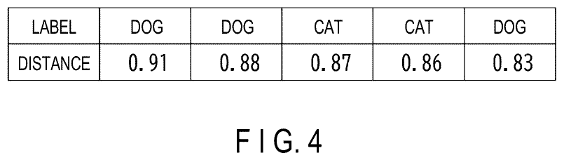

FIG. 4 is an exemplary table showing labels representing the classes of k (here, 5) reference data items determined by the neighborhood number determining unit 13 and the distances between an input data item and the 5 reference data items in the neighborhood of the input data item. FIG. 4 shows the 5 reference data items with the labels of dog or cat. As shown in FIG. 4, reference data items at a short distance do not necessarily have the same label (belong to the same class).

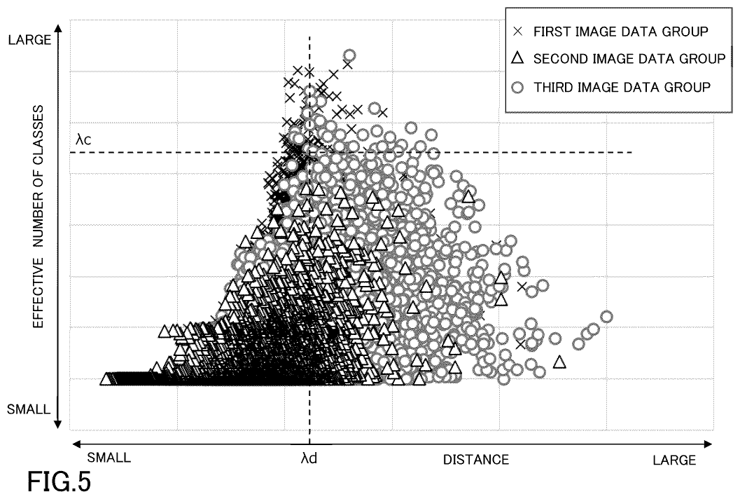

FIG. 5 illustrates an example of a plot in which three trained data groups (first to third image data groups) that are classified as OOD data or ID data and the features of which are known are plotted on a two-dimensional coordinate space represented by a distance and an effective number of classes. The distance on the horizontal axis is, for example, the distance related information representing the mean value of the distances of k reference data items. Image data items included in the first image data group are data items classified as OOD data. Image data items included in the second image data group are data items classified as OOD data. Image data items included in the third image data group are data items classified as ID data.

The threshold determining unit 16 according to the present embodiment adjusts the first threshold λd and the second threshold λc to adjust the proportions of the plotted points determined to be ID data or OOD data. Image data items that fall within a region where data items are not greater than the first threshold λd and not greater than the second threshold λc are classified as ID data. As illustrated in FIG. 5, the proportion of ID data increases with an increase in the first threshold λd and with an increase in the second threshold λc.

The threshold determining unit 16 adjusts the first threshold λd and the second threshold λc such that the proportion of ID data matches the certain recall. For example, in a case where the certain recall is 0.95, the threshold determining unit 16 adjusts the first threshold λd and the second threshold λc such that 95% of a plurality of input data items are determined to be ID data.

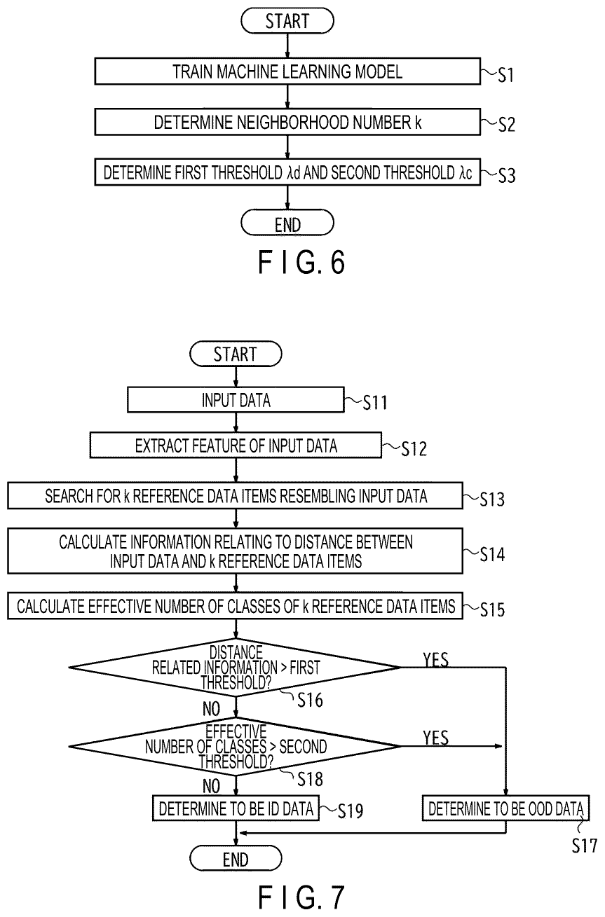

FIG. 6 is a flowchart illustrating a process of setting the first threshold λd and the second threshold λc. The process illustrated in the flowchart in FIG. 6 is executed mainly by the training unit 11, the neighborhood number determining unit 13, and the threshold determining unit 16.

First, the training unit 11 trains the machine learning model 10 that extracts features (S1). The training unit 11 inputs a plurality of training data items the features of which are known into the machine learning model 10 to cause the machine learning model 10 to perform the inference process and performs the training process of adjusting parameters of the machine learning model 10 such as weight coefficients such that the machine learning model 10 outputs desired (the known) features. A plurality of reference data items including features generated by the machine learning model 10 trained through the process by the training unit 11 are used in S2 and subsequent processes.

The neighborhood number determining unit 13 determines the value of the neighborhood number k for searching for k reference data items that resemble each of the plurality of training data items the features of which are known (S2). For example, the neighborhood number determining unit 13 decreases the value of neighborhood number k with a decrease in the number of reference data items of the same class.

Next, on the basis of the k reference data items searched for, for each of the plurality of training data items, the threshold determining unit 16 determines the first threshold λd and the second threshold λc such that the number of reference data items satisfying the above-described first condition and second condition matches the certain recall (S3).

FIG. 7 is a flowchart illustrating the process of determining ID data and OOD data. The process illustrated in the flowchart in FIG. 7 is executed mainly by the second feature extracting unit 17, the neighbor data searching unit 18, the second distance calculating unit 19, the second-number-of-classes calculating unit 20, and the determining unit 21.

First, the input device 2 inputs input data (S11). The input data is, for example, image data. The number of items of the input data can be one or more. Here will be described the process on one input data item.

Next, the second feature extracting unit 17 inputs the input data into the trained machine learning model 10 to cause the machine learning model 10 to perform the inference process. The second feature extracting unit 17 thus extracts the feature of the input data (S12).

After the feature of the input data is extracted, the subsequent processes are performed sequentially on the input data.

Next, the neighbor data searching unit 18 searches for k reference data items that resemble the input data in feature (S13).

Next, the second distance calculating unit 19 calculates the distances representing the differences in feature between the input data and the searched k reference data items (S14). More specifically, the second distance calculating unit 19 calculates the distance related information such as the mean value of the k distances, the total sum of the k distances, or the maximum value of the k distances.

Next, the second-number-of-classes calculating unit 20 calculates the effective number of classes of the k reference data items (S15). The effective number of classes is calculated by the Expression (1) described above.

Next, the determining unit 21 determines whether the distance related information calculated in S14 is greater than the first threshold λd (S16). In a case of YES in S16, the determining unit 21 determines that the input data corresponding to the distance related information calculated in S14 is OOD data (S17).

In a case of NO in S16, the determining unit 21 determines whether the effective number of classes calculated in S15 is greater than the second threshold λc (S18). In a case of YES in S18, the determining unit 21 determines that the input data is OOD data (S17).

In a case of NO in S18, the determining unit 21 determines that the input data is ID data (S19). As the process of S17 or S19 is completed, the process illustrated in the flowchart in FIG. 7 is completed. In a case where there are a plurality of input data items, the processes of S11 to S19 are repeated.

The input data determined to be ID data in the process illustrated in FIG. 7 is data resembling the reference data items and can thus be used in, for example, various processes such as inference. In contrast, the input data determined to be OOD data in the process illustrated in FIG. 7 is input data not resembling the reference data items and is thus excluded from targets of the various processes such as inference. In a case where the input data is determined to be OOD data, the information processing apparatus 1 may notify the outside of the information processing apparatus 1 that the input data is not a target of the various processes such as inference.

As seen from the above, in the present embodiment, reference data items based on training data items the features of which are known are used to determine the first threshold λd and the second threshold λc for determining ID data and OOD data. The first threshold λd is determined in accordance with the distances between the reference data items. The second threshold λc is determined based on the effective number of classes included in k reference data items that resemble the reference data items in feature. Next, in the present embodiment, for each input data item, k reference data items resembling the input data item in feature are searched for, and in a case where the distance related information relating to the distances to the k reference data items is greater than the first threshold λd, the input data item is determined to be OOD data. Additionally, in a case where the effective number of classes of the k reference data items resembling the input data item in feature is greater than the second threshold λc, the input data item is determined to be OOD data. This enables the process of determining ID data and OOD data to be performed with consideration given to the proportions of a plurality of label types included within a neighbor range of the input data item. It is thus possible to improve the accuracy of determining ID data and OOD data.

In some implementations of the present application, computer executable instructions stored in a computer readable medium may be executed by processing circuitry to perform the process illustrated in FIG. 7. A program executed by the processing circuitry may be stored in a recording medium such as a flexible disk or a CD-ROM and read and executed by a computer. The recording medium is not limited to a removable recording medium such as a magnetic disk or an optical disk and may be a non-removable recording medium such as a hard disk device or a memory device.

The stored program may be distributed over a communication channel such as the Internet (including wireless communication). Furthermore, the program may be encrypted or modulated and distributed in a compressed state over a wired communication channel or a wireless communication channel, or via a recording medium.

The information processing apparatus and the information processing method according to the embodiment can be summarized as follows, for example.

### [Supplements]

### [Item 1]

An information processing apparatus including:
a first storage device that stores a first threshold for determining a magnitude of information relating to k distances representing differences in feature between a first data item and k second data items, k being an integer equal to or greater than one, the k second data items resembling the first data item in feature;
a second storage device that stores a second threshold for determining a magnitude of a number of classes for classifying the k second data items according to classes; and
a control device that
   is connected to the first storage device and the second storage device,
   receives the first data item,
   calculates information relating to the k distances representing differences in feature between the received first data item and the k second data items that are searched for as data items resembling the first data item in feature,
   calculates the number of classes for classifying the k second data items searched for according to classes, and
   determines a third data item to be data out of a distribution range of a plurality of the second data items, the third data item being the first data item corresponding to a case where the calculated information is greater than the first threshold or to a case where the calculated number of classes is greater than the second threshold.

### [Item 2]

The information processing apparatus according to item 1, wherein
the number of classes is a value that reflects a proportion of one or more classes into which the k second data items are classified.

### [Item 3]

The information processing apparatus according to item 1, wherein
the number of classes takes a value closer to 1 as a proportion of one or more classes into which the k second data items are classified is more biased, and takes a value closer to a number of the one or more classes as the proportion is less biased.

### [Item 4]

The information processing apparatus according to any one of items 1 to 3, wherein
the control device determines the first threshold on a basis of the information relating to the k distances between the first data item and the k second data items and determines the second threshold on a basis of the number of classes included in the k second data items.

### [Item 5]

The information processing apparatus according to any one of items 1 to 4, wherein
the control device
   performs, on a machine learning model extracting a feature, a training process such that the machine learning model receiving training data with a known feature infers the known feature, and
   generates the plurality of the second data items using the trained machine learning model.

### [Item 6]

The information processing apparatus according to any one of items 1 to 5, further including
an output device outputting a result indicating that the first data item from which the calculated information relating to the distances is not greater than the first threshold and from which the calculated number of classes is not greater than the second threshold is determined as data within a distribution range of the plurality of the second data items.

### [Item 7]

The information processing apparatus according to any one of items 1 to 6, wherein
the control device determines the first threshold and the second threshold such that a total sum of a number of the second data items satisfying a first condition and a number of second data items, among the plurality of the second data items, satisfying a second condition equals a predetermined value, the first condition pertaining to the information relating to the k distances, the second condition pertaining to the number of classes included in the k second data items.

### [Item 8]

The information processing apparatus according to item 7, wherein
the first condition is a number of the second data items, among the plurality of the second data items, that make the information relating to the k distances not greater than the first threshold, and
the second condition is a number of the second data items, among the plurality of the second data items, that make the number of classes included in the k second data items not greater than the second threshold.

### [Item 9]

The information processing apparatus according to item 7 or 8, wherein
the predetermined value is a value obtained by multiplying a predetermined recall by a number of the plurality of the second data items, the predetermined recall being set in advance.

### [Item 10]

The information processing apparatus according to item 9, wherein
the control device increases a number of the second data items that are not greater than the first threshold and not greater than the second threshold as the predetermined recall increases.

### [Item 11]

The information processing apparatus according to item 9 or 10, wherein
the control device generates a plot in which plotted points representing the information relating to the distances between the plurality of the second data items and the number of classes are applied to a two-dimensional coordinate space represented by the information relating to the k distances between the plurality of the second data items and the number of classes included in the k second data items, and determines the first threshold and the second threshold such that a proportion of the plotted points included in an area in the plot where the information relating to the distances is not greater than the first threshold and where the number of classes is not greater than the second threshold matches the predetermined recall.

### [Item 12]

The information processing apparatus according to any one of items 1 to 11, wherein
the information relating to the distance is a mean value of the k distances, a total sum of the k distances, or a maximum value of the k distances.

### [Item 13]

The information processing apparatus according to any one of items 1 to 12, wherein
the plurality of the second data items and the first data item are image data items, and
the control device classifies the k second data items on a basis of classes of objects included in the image data items.

### [Item 14]

An information processing method including:
storing, in a first storage device, a first threshold for determining a magnitude of information relating to k distances representing differences in feature between a first data item and k second data items, k being an integer equal to or greater than one, the second data items resembling the first data item in feature;
storing, in a second storage device, a second threshold for determining a magnitude of a number of classes for classifying the k second data items according to classes;
receiving the first data item,
calculating information relating to the k distances representing differences in feature between the received first data item and the k second data items that are searched for as data items resembling the first data item in feature;
calculating the number of classes for classifying the k second data items searched for according to classes; and
determining a third data item to be data out of a distribution range of a plurality of the second data items, the third data item being the first data item corresponding to a case where the calculated information is greater than the first threshold or to a case where the calculated number of classes is greater than the second threshold.

Aspects of the present disclosure are not limited to the individual embodiments described above but can include various modifications conceivable to those skilled in the art. The advantageous effects of the present disclosure are not limited to the above-described content, either. That is, various additions, alterations, or partial deletions can be made without departing from the conceptual idea and gist of the present disclosure derived from the content provided in the claims and equivalents thereof.

What is claimed is:

1. An information processing apparatus comprising:
a first storage device configured to store a first threshold for determining a magnitude of information relating to k distances representing differences in feature between a first data item and k second data items, wherein k is an integer of one or more, and the k second data items resemble the first data item in feature;
a second storage device configured to store a second threshold for determining a magnitude of a number of classes for classifying the k second data items according to classes; and
processing circuitry that is connected to the first storage device and the second storage device, the processing circuitry is configured to:
receive the first data item;
search for the k second data items as data items resembling the first data item in feature;
calculate the information relating to the k distances representing differences in feature between the received first data item and the k second data items;
calculate the number of classes for classifying the k second data items according to the classes; and
determine a third data item to be data out of a distribution range of a plurality of the second data items, wherein
the third data item is the first data item in a case that the calculated information is greater than the first threshold, and
the third data item is the first data item in a case that the calculated number of classes is greater than the second threshold.

2. The information processing apparatus of claim 1, wherein
the number of classes is a value that reflects a proportion of one or more classes into which the k second data items are classified.

3. The information processing apparatus of claim 1, wherein
the processing circuitry is further configured to determine the first threshold on a basis of the information relating to the k distances between the first data item and the k second data items and determine the second threshold on a basis of the number of classes included in the k second data items.

4. The information processing apparatus of claim 2, wherein
the processing circuitry is further configured to determine the first threshold on a basis of the information relating to the k distances between the first data item and the k second data items and determine the second threshold on a basis of the number of classes included in the k second data items.

5. The information processing apparatus of claim 1, wherein
the processing circuitry is further configured to determine the first threshold and the second threshold such that a total sum of a number of second data items, among the plurality of the second data items, satisfying a first condition and a number of second data items, among the plurality of the second data items, satisfying a second condition equals a predetermined value, the first condition pertaining to the information relating to the k distances, and the second condition pertaining to the number of classes included in the k second data items.

6. The information processing apparatus of claim 1, wherein
the information relating to the distance is a mean value of the k distances, a total sum of the k distances, or a maximum value of the k distances.

7. The information processing apparatus of claim 1, wherein
the plurality of the second data items and the first data item are image data items, and
the processing circuitry is further configured to classify the k second data items on a basis of classes of objects included in the image data items.

8. The information processing apparatus of claim 1, wherein the processing circuitry is further configured to train a machine learning model to extract features by receiving a plurality of training data items having known features and adjusting weight coefficients of the machine learning model based on an inference process result.

9. The information processing apparatus of claim 8, wherein the processing circuitry is further configured to generate the k second data items as reference data using the trained machine learning model, and stores the reference data in a fourth storage device.

10. The information processing apparatus of claim 5, wherein the predetermined value is a value obtained by multiplying a certain recall set in advance by a number of the plurality of the second data items.

11. The information processing apparatus of claim 10, wherein the processing circuitry is further configured to increase at least one of the first threshold and the second threshold as the certain recall increases.

12. The information processing apparatus of claim 1, wherein the calculated number of classes matches a total number of label types included in the k second data items only in a case where proportions of the label types are equal.

13. The information processing apparatus of claim 1, wherein the processing circuitry is configured to search for the k second data items using a k-nearest neighbors algorithm.

14. The information processing apparatus of claim 1, wherein the calculated number of classes is an effective number of classes calculated based on a proportion of reference data items associated with a label type among the k second data items.

15. The information processing apparatus of claim 14, wherein the effective number of classes decreases as proportions of a plurality of label types included in the k second data items increase bias.

16. The information processing apparatus of claim 1, wherein the processing circuitry is further configured to determine the third data item is data out of the distribution range (OOD) when the calculated number of classes is smaller than a total number of label types included in the k second data items due to biased proportions of the label types.

17. An information processing method comprising:
storing a first threshold for determining a magnitude of information relating to k distances representing differences in feature between a first data item and k second data items, wherein k is an integer of one or more, and the second data items resemble the first data item in feature;
storing a second threshold for determining a magnitude of a number of classes for classifying the k second data items according to classes;
receiving the first data item;
searching for the k second data items as data items resembling the first data item in feature;
calculating the information relating to the k distances representing differences in feature between the received first data item and the k second data items;
calculating the number of classes for classifying the k second data items according to the classes; and
determining a third data item to be data out of a distribution range of a plurality of the second data items, wherein
the third data item is the first data item in a case that the calculated information is greater than the first threshold, and
the third data item is the first data item in a case that the calculated number of classes is greater than the second threshold.

18. The information processing method of claim 17, wherein
the number of classes is a value that reflects a proportion of one or more classes into which the k second data items are classified.

19. The information processing method of claim 17, further comprising:
determining the first threshold on a basis of the information relating to the k distances between the first data item and the k second data items; and
determining the second threshold on a basis of the number of classes included in the k second data items.

20. A non-transitory computer readable medium storing computer executable instructions which, when executed by processing circuitry of an information processing apparatus, causes the processing circuitry to perform a process comprising:
storing a first threshold for determining a magnitude of information relating to k distances representing differences in feature between a first data item and k second data items, wherein k is an integer of one or more, and the second data items resemble the first data item in feature;
storing a second threshold for determining a magnitude of a number of classes for classifying the k second data items according to classes;
receiving the first data item;
searching for the k second data items as data items resembling the first data item in feature;
calculating the information relating to the k distances representing differences in feature between the received first data item and the k second data items;
calculating the number of classes for classifying the k second data items according to the classes; and
determining a third data item to be data out of a distribution range of a plurality of the second data items, wherein
the third data item is the first data item in a case that the calculated information is greater than the first threshold, and
the third data item is the first data item in a case that the calculated number of classes is greater than the second threshold.
